(19) United States
(12) Patent Application Publication
(10) Pub. No.: US 2026/0164511 A1
(43) Pub. Date: Jun. 11, 2026

(54) HEATING DEVICES AND HEATING METHODS FOR SUBSTRATE GLASS PRODUCTION

(71) Applicant: CAIHONG DISPLAY DEVICES CO., LTD., Xianyang (CN)

(72) Inventors: Weidong HU, Xianyang (CN); Zhijun ZHANG, Xianyang (CN); Yongjing REN, Xianyang (CN); Ting LUO, Xianyang (CN)

(73) Assignee: CAIHONG DISPLAY DEVICES CO., LTD., Xianyang (CN)

(21) Appl. No.: 19/404,145

(22) Filed: Dec. 1, 2025

Related U.S. Application Data
(63) Continuation-in-part of application No. PCT/CN2025/113523, filed on Aug. 8, 2025.

(30) Foreign Application Priority Data
Dec. 5, 2024 (CN) 202411781196.2

(51) Int. Cl. H05B 3/64; C03B 17/06; F27D 1/00; F27D 99/00; H05B 3/66

(52) U.S. Cl. CPC H05B 3/64; C03B 17/067; F27D 1/0036; F27D 99/0006; H05B 3/66; F27D 2099/0008; F27M 2001/07

(57) ABSTRACT

A heating device and method for substrate glass production are provided. The device includes a furnace tray and multiple heating members. On the furnace tray's side facing the glass substrate, multiple grooves are arrayed along its height; each groove body penetrates the furnace tray along its length direction, with one heating member inside and extending along the groove body's length direction. Each heating member includes a fixing rod disposed in the groove body and fixedly mounted to the furnace tray and a heating wire wound around an outer circumferential surface of the fixing rod along a length direction of the fixing rod. In a thickness direction of the furnace tray, an outer diameter of the heating wire is greater than a height of the groove body. An inner side surface of the groove body has a reflective layer with a preset distance from the heating member.

### CROSS-REFERENCE TO RELATED APPLICATION

This application is a continuation-in-part of International Application No. PCT/CN2025/113523, filed on Aug. 8, 2025, which claims priority of Chinese Patent Application No. 202411781196.2, filed on Dec. 5, 2024, the contents of each of which are entirely incorporated herein by reference.

### TECHNICAL FIELD

The present disclosure relates to the technical field of substrate glass manufacturing, and specifically relates to heating devices and heating methods for substrate glass production.

### BACKGROUND

A substrate glass is one of key materials for flat panel display devices, and it is also a carrier for a panel manufacturing process. High requirements are placed on the flatness and heat stability of the substrate glass in use, especially with the development of high-generation and high-resolution display technology, requirements on a performance of the substrate glass are getting higher. An overflow-drawn substrate glass occupies an important market position due to its ability to achieve high surface quality without the need for secondary processing. However, the process control for this type of substrate glass is extremely challenging. When molten glass overflows and merges at a brick tip, as the glass descends, a reasonable distribution of temperature fields is required to realize the quality control. Therefore, it is necessary to install heating devices on both sides of the glass substrate to compensate for the temperature loss of glass substrate during cooling. Due to structural defects of a traditional heating device, a radiation region of heating wires in the heating radiation process is small, which not only results in incomplete heating of the glass substrate (compromising product quality), but also leads to low heating efficiency. At the same time, in a long-term production, a risk for the heating wires to burn out or break and fall off exists, which leads to a poor safety performance, and causes impact on the stability of production and the product quality.

### SUMMARY

The purpose of the present disclosure is to provide a heating device for substrate glass production, so as to solve the problems of poor product quality in production and low production safety in the prior art, which are caused by the small heating radiation region of the heating wires and their burnout or breakage.

To solve the above problems, the present disclosure provides the heating device for substrate glass production as follows.

The heating device for substrate glass production includes a furnace tray and a plurality of heating members. A side of the furnace tray close to a glass substrate is provided with a plurality of groove bodies, the plurality of groove bodies are arranged in an array along a height direction of the furnace tray, and for each of the plurality of groove bodies, the groove body penetrates through the furnace tray along a length direction of the furnace tray; one heating member is disposed in the groove body and extends along a length direction of the groove body. Each of the plurality of heating members includes a fixing rod and a heating wire. The fixing rod is disposed in the groove body and fixedly mounted to the furnace tray the heating wire is wound around an outer circumferential surface of the fixing rod along a length direction of the fixing rod, and in a thickness direction of the furnace tray, an outer diameter of the heating wire is greater than a height of the groove body; an inner side surface of the groove body is provided with a reflective layer, and a preset distance is provided between the reflective layer and the heating member.

In some embodiments, a thickness of the reflective layer is in a range of 1 mm- 1.2 mm.

In some embodiments, the preset distance is greater than or equal to 5 mm.

In some embodiments, along the length direction of the furnace tray, two sides of the furnace tray are provided with pressing strips, the pressing strips extend along the height direction of the furnace tray, and two ends of the fixing rod are fixedly connected to the pressing strips.

In some embodiments, the plurality of groove bodies are arranged at equal intervals along the height direction of the furnace tray, so that the plurality of heating members are arranged at equal intervals along the height direction of the furnace tray.

In some embodiments, the heating wire is a circular helical structure wound around the outer circumferential surface of the fixing rod.

In some embodiments, a ratio of a diameter of the fixing rod to an inner diameter of the heating wire is (0.8-0.9):1.

In some embodiments, a ratio of a height of the groove body to the outer diameter of the heating wire is less than 0.5.

In some embodiments, a cross section of the groove body is a semi-circle that matches a shape of the heating wire.

The present disclosure also provides a heating method for substrate glass production implemented based on the heating device in the embodiments of the present disclosure. The heating method includes the following operations.

The furnace tray is placed on both sides of the glass substrate, and a side with the heating member is arranged close to the glass substrate; and the heating wire is energized to heat the glass substrate.

Compared with the prior art, the heating device for substrate glass production provided by the embodiments of the present disclosure has beneficial effects including but not limited to the following.

By arranging the fixing rod fixedly mounted on the furnace tray, and winding the heating wire around the outer circumferential surface of the fixing rod along the length direction of the fixing rod, the heating wire is connected to the furnace tray via the fixing rod, which facilitates installation, enables long-term safely and reliable use, and solves the problem in the prior art where the heating wire are prone to burn out, fall off, or pose such risks during long-term production, thereby improving production stability and product quality. Meanwhile, in the thickness direction of the furnace tray, the outer diameter of the heating wire is greater than the height of the groove body on the furnace tray. During use, this allows the radiation angle of the heating wire relative to the glass substrate to be greater than 120 °, ensuring complete heating of the glass substrate, which improves the product quality and the heating efficiency. In addition, the inner side surface of the groove body is provided with the reflective layer, and a certain distance (e.g., a preset distance) is maintained between the reflection layer and the outer surface of the heating wire. This prevents direct contact between the heating wire and the furnace tray, ensuring good reflection and heat dissipation effects.

The thickness of the reflective layer is 1 mm- 1.2 mm, which further enhances the reflective and heat dissipation effects.

The distance between the reflective layer and the outer surface of the heating wire is greater than or equal to 5 mm, which further improves the reflective and heat dissipation effects.

The groove bodies are arranged at equal intervals along the height direction of the furnace tray, so that the heating members are also arranged at equal intervals along the height direction of the furnace tray, ensuring heating uniformity.

### BRIEF DESCRIPTION OF THE DRAWINGS

FIG. 1 is a schematic diagram illustrating a structure of a heating device for substrate glass production in the prior art;

FIG. 2 is a schematic diagram illustrating a structure of a local heating unit of the heating device for substrate glass production in the prior art;

FIG. 3 is a schematic diagram illustrating a structure of a fixed wire ablation in the heating device for substrate glass production in the prior art;

FIG. 4 is a schematic diagram illustrating a three-dimensional (3D) structure of a heating device for substrate glass production according to some embodiments of the present disclosure;

FIG. 5 is a front view of a structure of a heating device for substrate glass production according to some embodiments of the present disclosure;

FIG. 6 is a schematic diagram illustrating a structure of a local heating unit of a heating device for substrate glass production according to some embodiments of the present disclosure; and

FIG. 7 is a schematic diagram illustrating an inner diameter and an outer diameter of a heating wire according to some embodiments of the present disclosure.

Reference signs: 1, glass substrate; 2, heat radiation region; 3, existing heating device; 31, fixed tray; 32, spring-shaped wire; 33, metal fixing wire; 34, ablation; 35, outer diameter of the spring-shaped wire; 4, heating device; 41, furnace tray; 42, heating wire; 43, fixing rod; 44, pressure strip; 45, screw; 46, reflective layer.

### DETAILED DESCRIPTION

To enable those skilled in the art to better understand the embodiments of the present disclosure, the technical solutions in the embodiments of the present disclosure are clearly and completely described below with reference to the accompanying drawings, and it is evident that the described embodiments are merely a part of the embodiments of the present disclosure, rather than all the embodiments. Based on the embodiments of the present disclosure, all other embodiments obtained by those of ordinary skill in the art without making creative efforts shall fall within the protection scope of the present disclosure.

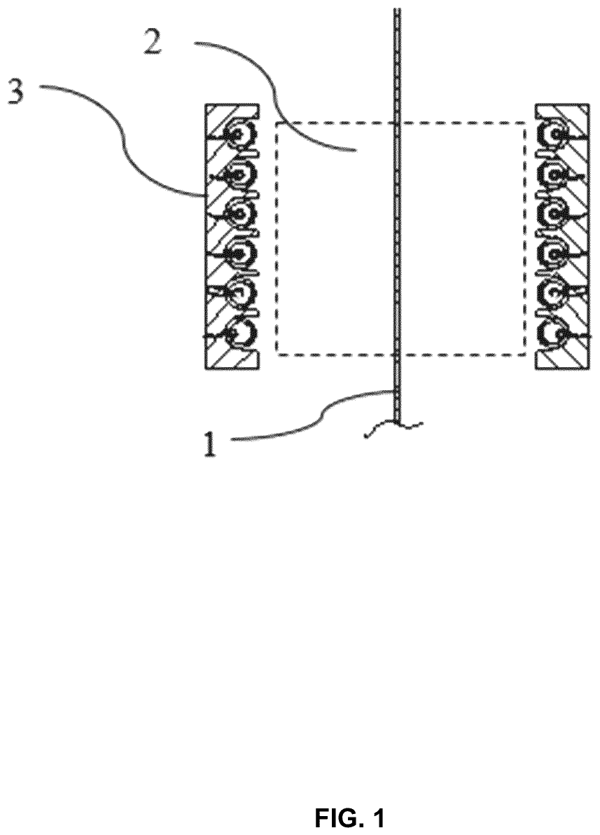

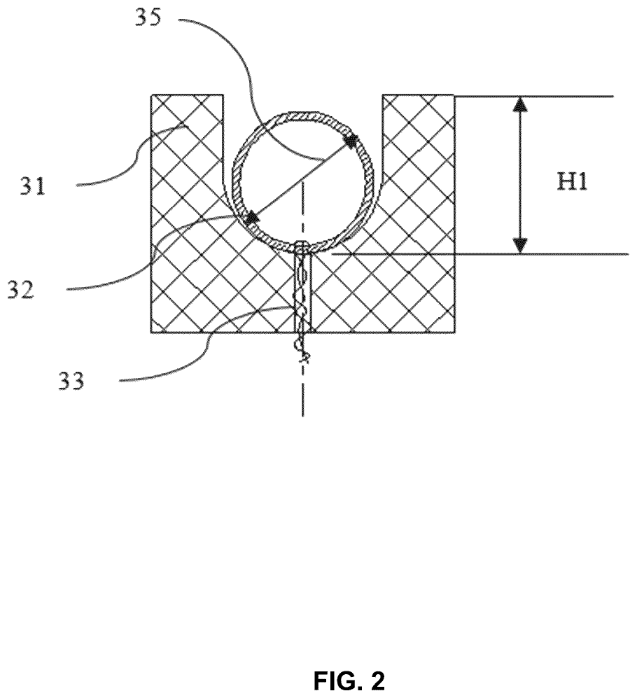

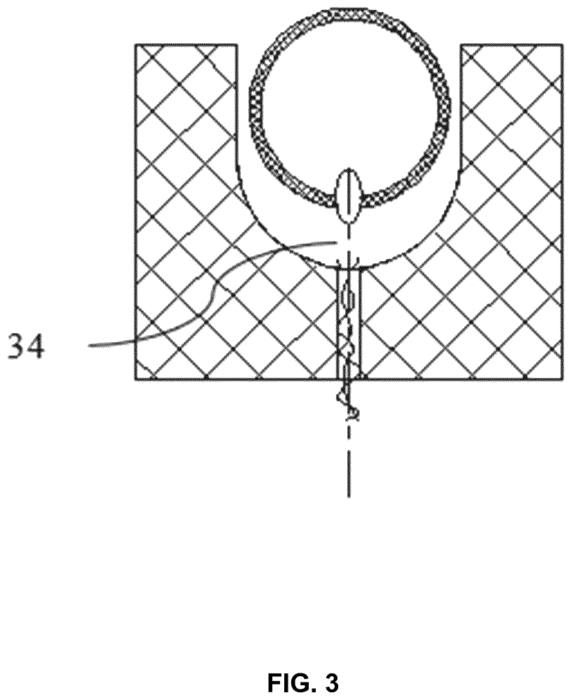

FIG. 1 is a schematic diagram illustrating a structure of a heating device for substrate glass production in the prior art; FIG. 2 is a schematic diagram illustrating a structure of a local heating unit of the heating device for substrate glass production in the prior art; and FIG. 3 is a schematic diagram illustrating a structure of a fixed wire ablation in the heating device for substrate glass production in the prior art.

As noted in the background art, the heating device in the prior art (referred to as the “existing heating device”) results in poor product quality and low production safety due to the small heating radiation region of the heating wire and its burnout. Specifically, referring to FIGS. 1-3, an existing heating unit 3 is distributed on both sides of a glass substrate 1, and heats and compensates for temperature differences according to an actual temperature difference of the glass substrate 1. Referring to FIG. 2, the existing heating device 3 includes a fixed furnace tray 31, a heating wire, and a metal fixing wire 33. In use, the heating wire is spring-shaped (i.e., a spring-shaped wire 32), which is placed into a corresponding groove body of the fixed furnace tray 31 and fixed by the metal fixing wire 33. After the spring-shaped wire 32 is energized to generate heat, the existing heating device 3 disposed on both sides of the glass substrate 1 heats the glass substrate 1 in the corresponding region through a heat radiation region 2.

However, in the existing heating device 3, the spring-shaped wire 32 is entirely placed directly in the groove body and is in contact with a bottom of the groove body. Meanwhile, a height H1 of the groove body is greater than an outer diameter 35 of the spring-shaped wire, resulting in a heating radiation angle of the spring-shaped wire 32 being within 90°, and a small radiation region. In addition, the energization and heating process causes the spring-shaped wire 32 to deform due to thermal expansion, some parts of the spring-shaped wire 32 may break away from the groove body, or the metal fixing wire 33 may loosen, leading to spark-induced burnout. Moreover, long-term high temperatures may cause ablation 34 of the metal fixing wire 33 as shown in FIG. 3.

Therefore, for the above reasons, some embodiments of the present disclosure provide a heating device for substrate glass production to ensure safety, reliability, and stability in production, and to improve product quality and heating efficiency.

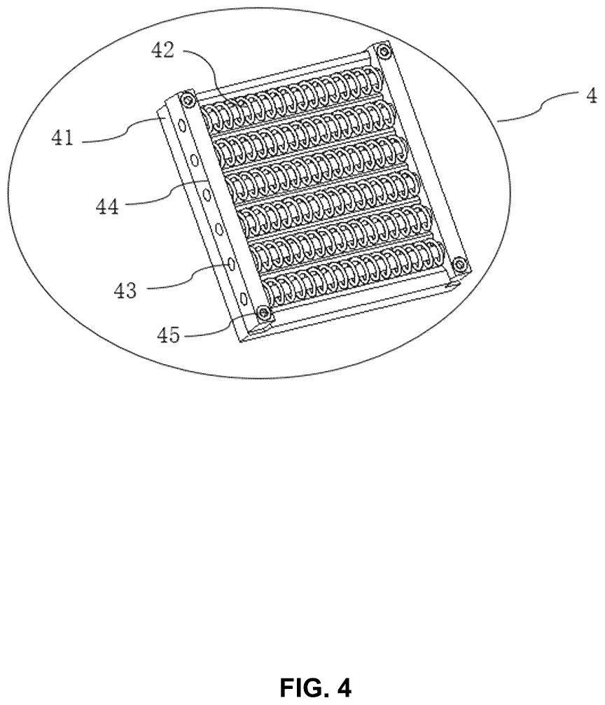

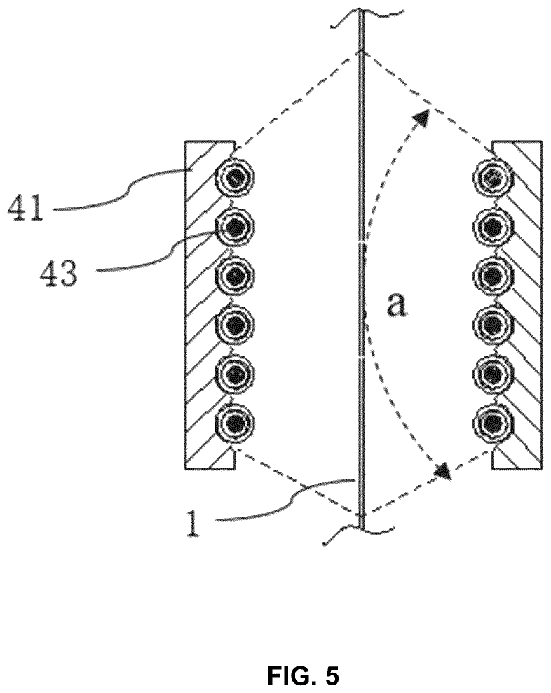

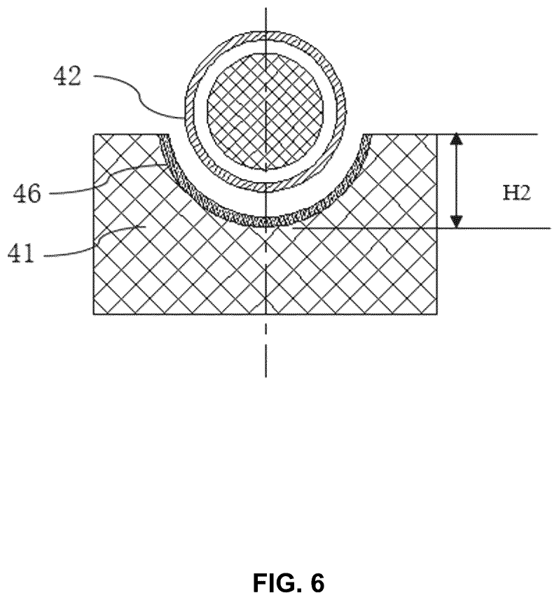

FIG. 4 is a schematic diagram illustrating a three-dimensional (3D) structure of a heating device for substrate glass production according to some embodiments of the present disclosure; FIG. 5 is a front view of a structure of a heating device for substrate glass production according to some embodiments of the present disclosure; and FIG. 6 is a schematic diagram illustrating a structure of a local heating unit of a heating device for substrate glass production according to some embodiments of the present disclosure.

The heating device for substrate glass production provided in some embodiments of the present disclosure is a new type of heating device 4. In some embodiments, as shown in FIG. 4, the heating device 4 includes a furnace tray 41 and a plurality of heating members.

The furnace tray 41 is configured to install heating members, and the heating members are configured to heat the glass substrate 1. The glass substrate 1 refers to a glass formed during a production process of the substrate glass (such as an overflow process) that requires heating for further shaping. The glass substrate 1 has preset glass dimensions (e.g., a length, a width) according to the requirements of the production process.

In some embodiments, a side of the furnace tray 41 close to a glass substrate 1 is provided with a plurality of groove bodies, the plurality of groove bodies are arranged in an array along a height direction of the furnace tray 41, and each of the plurality of groove bodies penetrates through the furnace tray 41 along a length direction of the furnace tray 41. The plurality of heating members are respectively disposed in the groove bodies and extend along a length direction of the groove bodies. The groove bodies are configured to accommodate the heating members, and size, shape, and count of the groove bodies may be preset according to actual needs.

The heating member includes a fixing rod 43 and a heating wire 42.

The fixing rod 43 is disposed in the groove body along the length direction of the groove body and is fixedly mounted on the furnace tray 41. The fixing rod 43 is used to fix and mount the heating wire 42, thereby securing the heating wire 42 to the furnace tray 41 and preventing the heating wire 42 from disengaging from the groove body, thereby ensuring safety, reliability, and stability in production. The fixing rod 43 is made of a high-temperature-resistant refractory material.

The heating wire 42 is wound around an outer circumferential surface of the fixing rod 43 along the length direction of the fixing rod 43, and in a thickness direction of the furnace tray 41, an outer diameter of the heating wire 42 is greater than a height H2 of the groove body. In some embodiments, during use, after the heating wire 42 is energized, the heating wire 42 has a radiation angle α relative to the glass substrate 1 (as shown in FIG. 5), and the heating wire 42 is stably mounted on the fixing rod 43. In some embodiments, the radiation angle α of the heating wire 42 relative to the glass substrate 1 is greater than 120°.

In some embodiments, an inner side surface of the groove body is provided with a reflective layer 46 for reflecting thermal energy from the heating wire. A material of the reflective layer may be determined based on requirements (e.g., cost, heat reflectivity, heat resistance, thermal conductivity). For example, the material of the reflective layer includes, but is not limited to, one or a combination of stainless steel foil, aluminum foil, ceramic, etc.

In some embodiments, the reflective layer is a highly reflective layer made of a high-temperature resistant material with a high heat reflectivity (e.g., greater than 90%), and a preset distance is maintained between the reflective layer 46 and the heating member, preventing direct contact the heating wire 42 and the furnace tray 41, which ensures good reflection and heat dissipation effects. The distance between the reflective layer 46 and the heating member refers to a distance between the reflective layer and an outer contour of the heating wire.

When the heating wire 42 is energized to emit heat, it heats a region of the glass substrate 1 through heat reflection from the reflective layer 46 and heat radiation from the exposed portion. At the same time, the heating wire 42 does not come into direct contact with the furnace tray 41 and requires no additional metal material for fixation, thereby ensuring good insulation and heat dissipation in the energized state, and enabling long-term safe use.

In some embodiments, a thickness of the reflective layer 46 is in a range of 1 mm-1.2 mm, and the preset distance between the reflective layer 46 and the outer surface of the heating wire 42 is greater than or equal to 5 mm.

In some embodiments, the thickness of the reflective layer 46 is 1 mm, and the preset distance between the reflective layer 46 and the outer surface of the heating wire 42 is 5 mm.

In some embodiments, the thickness of the reflective layer 46 is 1.2 mm, and the preset distance between the reflective layer 46 and the outer surface of the heating wire 42 is 7 mm.

In some embodiments, the thickness of the reflective layer 46 is 1.1 mm, and the preset distance between the reflective layer 46 and the outer surface of the heating wire 42 is 6 mm.

In some embodiments of the present disclosure, by providing a certain distance between the reflective layer and the heating wire, the heating wire is prevented from direct contact with the furnace tray, ensuring good reflection and heat dissipation effects.

In some embodiments, the heating wire 42 is a circular helical structure wound around the outer circumferential surface of the fixing rod 43, and a cross section of the groove body is a semi-circle that matches a shape of the heating wire 42; a ratio of a diameter of the fixing rod 43 to an inner diameter of the heating wire 42 is (0.8 to 0.9):1; and a ratio of a height H2 of the groove body to the outer diameter of the heating wire 42 is less than 0.5.

In some embodiments, the ratio of the diameter of the fixing rod 43 to the inner diameter of the heating wire 42 is 0.8:1; and the ratio of the height H2 of the groove body to the outer diameter of the heating wire 42 is 0.4.

In some embodiments, the ratio of the diameter of the fixing rod 43 to the inner diameter of the heating wire 42 is 0.85:1; and the ratio of the height H2 of the groove body to the outer diameter of the heating wire 42 is 0.4.

In some embodiments, the heating wire 42 is an oval helical structure wound around the outer circumferential surface of the fixing rod 43, and the cross section of the groove body is an oval that matches the shape of the heating wire 42.

In some embodiments, the ratio of the diameter of the fixing rod 43 to the inner diameter of the heating wire 42 is 0.9:1; and the ratio of the height H2 of the groove body to the outer diameter of the heating wire 42 is 0.2.

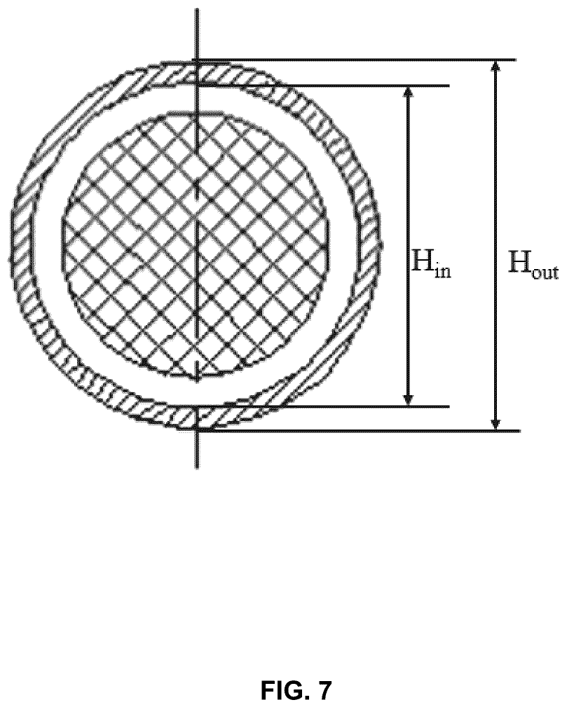

It should be noted that the heating wire 42 wound around the outer circumferential surface of the fixing rod 43 forms a helical structure (e.g., a circular helical structure, an oval helical structure), which has a cross-section with a specific shape (e.g., circular, oval), and the heating wire 42 itself has a specific size (e.g., radius or diameter) according to process requirements. The inner diameter of the heating wire 42 refers to the minimum distance of the inner contour (shape) of the helical structure in a direction parallel to the height of the groove body (i.e., in the thickness direction of the furnace tray 41), and the outer diameter of the heating wire 42 refers to the maximum distance of the outer contour of the helical structure in the direction parallel to the height of the groove body. As shown in FIG. 7, Hᵢₙ and Hₒᵤₜ are the inner diameter and the outer diameter of the heating wire 42, respectively.

For example, with reference to FIG. 6, for the circular helical structure, its cross-section includes an inner circle formed by the inner contour of the heating wire 42 and an outer circle formed by the outer contour of the heating wire 42, the inner diameter of the heating wire 42 is a diameter of the inner circle, and the outer diameter of the heating wire 42 is a diameter of the outer circle. As another example, for the oval helical structure (not shown in the figures), taking its cross-section as an oval that is narrow in the middle and wide on both sides (i.e., a short axis direction of the oval is parallel to the height direction of the groove body), the cross-section includes an inner oval formed by the inner contour of the heating wire 42 and an outer oval formed by the outer contour of the heating wire 42. The inner diameter of the heating wire 42 is a length of the minor axis of the inner oval, and the outer diameter of the heating wire 42 is a length of the minor axis of the outer oval.

In some embodiments of the present disclosure, by setting the ratio of the diameter of the fixing rod to the inner diameter of the heating wire to be less than 1 (e.g., 0.8, 0.9), a gap is formed between the heating wire and the fixing rod to prevent the heating wire from expanding, thereby avoiding collision with the fixed rod—which leads to deformation or damage of the heating wire and improves the reliability and safety of the heating wire during operation. In addition, by setting the ratio of the height H2 of the groove body to the outer diameter of the heating wire 42 to be less than a preset ratio (e.g., 0.5), the helical structure formed by the heating wire protrudes form the groove body, ensuring that the radiation angle α of the heating wire relative to the glass substrate 1 meets production requirements.

Based on the technical concept of the present disclosure described above, or on the basis of the embodiment described above, another embodiment of a heating device for substrate glass production is provided below.

Continuing to refer to FIG. 4, in some embodiments, along the length direction of the furnace tray 41, two sides of the furnace tray 41 are provided with pressing strips 44. The pressing strips 44 are provided in the height direction of the furnace tray 41, and two ends of the fixing rod 43 are fixedly connected to the pressing strips 44. The pressing strips 44 are fixedly mounted on the furnace tray 41 through screws 45; the pressing strips 44 are provided with mounting holes corresponding to the fixing rod 43, and the two ends of the fixing rod 43 are mounted in the corresponding mounting holes.

For example, there are 6 groove bodies on the furnace tray 41, and for each pressure strip 44 on both sides of the furnace tray 41, 6 mounting holes are provided along the length direction of the pressure strip 44 (i.e., the height direction of the furnace tray 41), and the mounting holes on each pressure strip 44 corresponds to the groove bodies. One end of each of the fixing rods 43 may be inserted into one of the mounting holes of the pressure strips 44, thereby enabling each of the fixing rods 43 to be fixedly connected to the pressure strips 44 on both sides of the furnace tray 41. In some embodiments of the present disclosure, by providing the pressing strips 44 with mounting holes on the furnace tray 41, each fixing rod 43 is stably disposed on the furnace tray 41, and in addition, this allows the heating members to be detachably mounted in the heating device according to actual requirements (e.g., the count of the heating members), enhancing the flexibility and maintainability of the heating device.

In some embodiments, the pressing strips 44 are provided with a plurality of rows of mounting holes, and the plurality of mounting holes corresponding to the plurality of rows of mounting holes form a matrix-type mounting hole structure.

The mounting holes along the length direction of the pressure strips 44 (i.e., the height direction of the furnace tray 41) are hereinafter referred to as “row mounting holes” and they correspond respectively to the groove bodies arranged in an array. For the mounting holes within each row of mounting holes (hereinafter referred to as “column mounting holes”), one end of each fixing rod 43 may be inserted into one of the mounting holes of the pressing strips 44, thereby enabling each fixing rod 43 to be fixedly connected to the pressing strips 44 on both sides of the furnace tray 41.

In actual production scenarios, for each groove body, different column mounting holes may be selected from the corresponding row mounting holes to mount the fixing rod 43, so as to adjust a position of the heating wire to satisfy actual process requirements (e.g., a desired radiation angle α, a coverage area of the heat radiation region, etc.). It should be understood that after the fixing rod 43 is installed through the different column mounting holes, the distance between the heating wire corresponding to the fixing rod 43 and the reflective layer, and/or the radiation angle α corresponding to the heating wire may vary.

Merely by way of example, there are m (e.g., 6) groove bodies on the furnace tray 41, and there are n (e.g., 2) rows of mounting holes on the pressure strips 44, thereby forming a 6-row and 2-column matrix-type mounting hole structure. In practical applications, different column mounting holes may be selected to install the fixing rods in different groove bodies. For example, all fixing rods are installed using the same column mounting holes (e.g., the first or second column). Alternatively, the fixing rods corresponding to different groove bodies may also independently select different column mounting holes for installation, thereby adjusting the heat radiation area of the glass substrate 1 through the heat radiation angles of the heating wires in different groove bodies.

In some embodiments of the present disclosure, by setting the matrix-type mounting hole structure, it is possible to adjust the radiation angle of the heating wire relative to the glass substrate in a targeted manner according to actual needs, further improve product quality and heating efficiency.

In some other embodiments, the mounting holes on the pressing strips 44 are of an oblong hole structure, and limit mechanisms are provided in the mounting holes. The oblong holes have a preset length in the thickness direction of the pressing strips 44 (i.e., the height direction of the furnace tray 41), and the limiting mechanisms are used to adjust the position of one end of the fixing rod 43 in the oblong holes.

In some embodiments, a limiting mechanism includes a retractable bayonet, and a groove (e.g., a circular groove) is provided at an end of the fixing rod 43. The groove is configured to cooperate with the limiting mechanism to fix the fixing rod 43. For example, a plurality of bayonets (e.g., 2, 3, etc.) capable of extending deep into the oblong holes are provided on a side of the pressing strip 44 away from the glass substrate 1, and different bayonets are provided at different positions in the thickness direction of the pressing strips 44 at preset intervals, and the preset intervals is determined according to the diameter of the fixing rod 43 (e.g., 1.5 times the diameter of the fixing rod 43, etc.). When a certain bayonet extends into the oblong hole, it may engage with the groove at the end of the fixing rod 43, thereby fixedly connecting the fixing rod 43 to the pressing strip 44 and fixing the fixing rod 43 at a target position in the oblong hole (a position of the bayonet).

In some embodiments of the present disclosure, considering that the pressing strips 44 need to be fixed to the furnace tray 41 through the screws 45, the provision of limiting mechanisms allows for convenient adjustment of the position of the fixing rod 43 during production without disassembling the pressing strips or the heating device 4. This enables adjustment of the position of the heating wire, improving production efficiency while enhancing the heating efficiency of the glass substrate.

In some embodiments, the groove bodies may be arranged at unequal intervals along the height direction of the furnace tray 41, in such cases, the heating members are also arranged at unequal intervals along the height direction of the furnace tray 41. In some embodiments, considering the potential issue of uneven heating when the heating wire 42 heats the glass substrate 1, the groove bodies are arranged at equal intervals along the height direction of the furnace tray 41 so that the heating members are also arranged at equal intervals along the height direction of the furnace tray 41 to ensure the heating uniformity of the heating wire 42 when heating the glass substrate 1.

In some embodiments, the heating device for substrate glass production provided in some embodiments of the present disclosure further includes a monitoring device. The monitoring device may be various types of sensors, which include, but are not limited to, a temperature sensor, an image acquisition device (e.g., a camera device). The temperature sensor may be configured to obtain temperature information of different heating regions of the glass substrate 1, and the image acquisition device may obtain images of the glass substrate 1 to determine a thermal map of the glass substrate 1.

Some embodiments of the present disclosure provide an installation method for the heating device for substrate glass production including the following operations S10-S40.

In S10, a plurality of groove bodies arranged in an array along the height direction of the furnace tray 41 are formed on a side of the furnace tray 41 close to the glass substrate 1. In some embodiments, an inner surface of each groove body is provided with a reflective layer 46, the groove body penetrates through the furnace tray 41 along the length direction of the furnace tray 41, and a thickness of the reflective layer 46 is in a range of 1 mm-1.2 mm.

In S20, the fixing rod 43 passes through the heating wire 42, and two ends of the fixing rod 43 are inserted into the corresponding mounting holes of the pressing strips 44.

In some embodiments, the heating wire 42 is wound around an outer circumferential surface of the fixing rod 43 to form the heating member, and the heating member is disposed in the groove body along the length direction of the groove body. In some embodiments, the heating wire 42 is wound around the outer circumferential surface of the fixing rod 43 along the length direction of the fixing rod 43, and the heating member is fixedly mounted to the furnace tray 41, and in the thickness direction of the furnace tray 41, the outer diameter of the heating wire 42 is greater than the height of the groove body. In some embodiments, the ratio of the height of the groove body to the outer diameter of the heating wire 42 is less than 0.5; the ratio of the diameter of the fixing rod 43 to the inner diameter of the heating wire 42 is in a range of (0.8-0.9):1; and the distance between the reflective layer 46 and the outer surface of the heating wire 42 is greater than or equal to 5 mm. In some embodiments, the fixing rod 43 is disposed in the groove body along the length direction of the groove body, and the two ends of the fixing rod 43 are fixedly connected with the pressure strips 44 provided on both sides of the furnace tray 41 via screws 45, so that the heating member is fixedly connected to the furnace tray 41.

In some embodiments, the pressing strips 44 are provided with a plurality of rows of mounting holes, and the two ends of the fixing rods 43 corresponding to different groove bodies are inserted into the corresponding mounting holes of the pressing strips 44. In some embodiments, the mounting holes on the pressing strips 44 are of an oblong hole structure, limiting mechanisms are provided in the mounting holes, and the ends of the fixing rods 43 are provided with grooves. The two ends of the fixing rod 43 are inserted into the target positions of the corresponding mounting holes of the pressing strips 44, and the bayonets of the limiting mechanisms extend into the oblong holes to engage with the grooves at the ends of the fixing rod 43.

In S30, the pressing strips 44 are fixed to the furnace tray 41 via screws 45.

In S40, the assembled heating device is placed symmetrically on both sides of the glass substrate 1, and the heating wire 42 is energized for operation. A distance between the assembled heating device and the glass substrate 1 is determined according to the actual process requirements, which is set by technicians based on experience.

Some embodiments of the present disclosure provide a heating method for substrate glass production based on the above-described heating device for substrate glass production. The heating method includes the following operations S1-S2:

In S1, the furnace tray 41 is placed on both sides of the glass substrate 1, and the side with the heating member is arranged close to the glass substrate 1.

In S2, the heating wire 42 is energized to heat the glass substrate 1.

In some embodiments, in S2, process production parameters are determined based on glass substrate quality requirement information. The glass substrate quality requirement information includes, but is not limited to, sizes (e.g., a length, a width, a thickness, etc.) of the glass substrate 1, the process production parameters include, but are not limited to, a current value or a voltage value during energization, heating region information (e.g., a position, an area) of the glass substrate 1, and temperature field distribution information (e.g., temperatures of different heating regions) of the glass substrate 1. In some embodiments, device parameters of the heating device are further determined based on the process production parameters. The device parameters of the heating device include, but are not limited to, a target heating wire (a heating wire to be energized) and a count of the target heating wire, the radiation angle of the heating wire relative to the glass substrate 1, and the distance between the reflective layer and the heating wire. The radiation angle and the distance between the reflective layer and the heating wire may be adjusted by adjusting the position of the fixing rod, and the radiation angle and the distance between the reflective layer and the heating wire may be determined according to production experience (e.g., a production process reference table). Exemplarily, the production process reference table refers to a relationship table constructed based on historical experience, which links the glass substrate quality requirement information, the process production parameters, and the device parameters of the heating device.

In some embodiments, when the glass substrate 1 is heated, the process production parameters and/or the device parameters of the heating device are adjusted based on heating feedback information. The heating feedback information includes, but is not limited to, the temperatures of different heating regions of the glass substrate 1, a thermal map of the glass substrate 1. The heating feedback information may be obtained by the monitoring device (e.g., the temperature sensor and the image acquisition device). Exemplarily, the positions of the one or more target heating wires are fine-tuned via the limiting mechanisms of the pressing strips based on the temperature monitoring information, which enables a fine adjustment of the radiation angles of the one or more target heating wires to adjust an area of the heat radiation region that the heating device 4 applies to the glass plate 1, as well as the heating efficiency, etc. ; further, the current or the voltage of the target heating wires are also adjusted to modify the heating intensity applied to the glass substrate 1.

In some embodiments of the present disclosure, by utilizing the heating feedback information, it is possible to adjust the device parameters of the heating device during the heating process of the glass substrate 1 while ensuring production stability, thereby guaranteeing the product stability.

The foregoing is merely a preferred embodiment of the present disclosure, and is not intended to limit the present disclosure. The protection scope of the present disclosure is subject to the claims, and similarly, any equivalent structural changes made by utilizing the contents of the present disclosure and the accompanying drawings shall be included in the protection scope of the present disclosure.

What is claimed is:

1. A heating device for substrate glass production, comprising: a furnace tray and a plurality of heating members, wherein
a side of the furnace tray close to a glass substrate is provided with a plurality of groove bodies, the plurality of groove bodies are arranged in an array along a height direction of the furnace tray, and for each of the plurality of groove bodies, the groove body penetrates through the furnace tray along a length direction of the furnace tray; one heating member is disposed in the groove body and extends along a length direction of the groove body;
each of the plurality of heating members includes a fixing rod and a heating wire, wherein
the fixing rod is disposed in the groove body and fixedly mounted on the furnace tray;
the heating wire is wound around an outer circumferential surface of the fixing rod along a length direction of the fixing rod, and in a thickness direction of the furnace tray, an outer diameter of the heating wire is greater than a height of the groove body; an inner side surface of the groove body is provided with a reflective layer, and a preset distance is provided between the reflective layer and the heating member.

2. The heating device of claim 1, wherein a thickness of the reflective layer is in a range of 1 mm-1.2 mm.

3. The heating device of claim 2, wherein the preset distance is greater than or equal to 5 mm.

4. The heating device of claim 1, wherein along the length direction of the furnace tray, two sides of the furnace tray are provided with pressing strips, the pressing strips extend along the height direction of the furnace tray, and two ends of the fixing rod are fixedly connected to the pressing strips.

5. The heating device of claim 1, wherein the plurality of groove bodies are arranged at equal intervals along the height direction of the furnace tray, so that the plurality of heating members are arranged at equal intervals along the height direction of the furnace tray.

6. The heating device of claim 1, wherein the heating wire is a circular helical structure wound around the outer circumferential surface of the fixing rod.

7. The heating device of claim 6, wherein a ratio of a diameter of the fixing rod to an inner diameter of the heating wire is (0.8-0.9):1.

8. The heating device of claim 7, wherein a ratio of a height of the groove body to the outer diameter of the heating wire is less than 0.5.

9. The heating device of claim 8, wherein a cross section of the groove body is a semi-circle that matches a shape of the heating wire.

10. A heating method for substrate glass production implemented based on the heating device of claim 1, comprising:
placing the furnace tray on both sides of the glass substrate, and arranging a side with the heating member close to the glass substrate; and
energizing the heating wire to heat the glass substrate.
